(19) United States
(12) Patent Application Publication
(10) Pub. No.: US 2023/0419020 A1
(43) Pub. Date: Dec. 28, 2023

(54) Machine Learning Based Document Visual Element Extraction

(71) Applicant: Google LLC, Moutain View, CA (US)

(72) Inventors: Nikolay Glushnev, Woodinville, WA (US); Qingze Wang, San Jose, CA (US); Emmanouil Koukoumidis, Kirkland, WA (US); Henry Wahyudi Setiawan, Bellevue, WA (US); Lauro Ivo Beltrao Colaco Costa, Kirkland, WA (US); Vincent Perot, Brooklyn, NY (US)

(73) Assignee: Google LLC, Mountain View, CA (US)

(21) Appl. No.: 17/808,293

(22) Filed: Jun. 22, 2022

(51) Int. Cl. G06F 40/174; G06V 30/412; G06V 30/19

(52) U.S. Cl. CPC G06F 40/174; G06V 30/412; G06V 30/19

(57) ABSTRACT

A method includes obtaining a document with textual fields and a visual element. For each textual field, the method includes determining a textual offset for the textual field that indicates a location of the textual field relative to each other textual field in the document. The method includes detecting, using a machine learning vision model, the visual element and determining a visual element offset indicating a location of the visual element relative to each textual field in the document. The method includes assigning the visual element a visual element anchor token and inserting the visual element anchor token into the textual fields in an order based on the visual element offset and the respective textual offsets. The method also includes, after inserting the visual element anchor token, extracting, using a text-based extraction model, from the textual fields, structured entities representing the series of textual fields and the visual element.

### TECHNICAL FIELD

This disclosure relates to machine learning based document visual element extraction.

### BACKGROUND

Entity extraction is a popular technique that identifies and extracts key information from text. Entity extraction tools may classify the information into predefined categories which coverts previously unstructured data into structured data that downstream applications may use in any number of ways. For example, entity extraction tools may process unstructured data to extract data from documents or forms to automate many data entry tasks.

### SUMMARY

One aspect of the disclosure provides a method for extracting visual elements from a document. The computer-implemented method, when executed by data processing hardware, causes the data processing hardware to perform operations. The operations include obtaining a document that includes a series of textual fields and a visual element. For each respective textual field of the series of textual fields, the method includes determining a respective textual offset for the respective textual field. The respective textual offset indicates a location of the respective textual field relative to each other textual field of the series of textual fields in the document. The method includes detecting, using a machine learning vision model, the visual element and determining a visual element offset indicating a location of the visual element relative to each textual field of the series of textual fields in the document. The method includes assigning the visual element a visual element anchor token and inserting the visual element anchor token into the series of textual fields in an order based on the visual element offset and the respective textual offsets. After inserting the visual element anchor token into the series of textual fields, the method includes extracting, using a text-based extraction model, from the series of textual fields, a plurality of structured entities that represent the series of textual fields and the visual element.

Implementations of the disclosure may include one or more of the following optional features. In some implementations, the visual element includes a checkbox. Optionally, the visual element includes a radio button. For each respective textual field of the series of textual fields, the respective textual offset may include a position within an array. Each position within the array may be associated with a character of one of the series of textual fields.

In some examples, detecting the visual element includes detecting a label of the visual element and detecting a value of the visual element. In some of these examples, determining the visual element offset indicating the location of the visual element includes determining a first offset for the label of the visual element and determining a second offset for the value of the visual element.

Optionally, the visual element anchor token represents a Boolean entity indicating a status of the visual element. In some implementations, the machine learning vision model comprises an optical character recognition (OCR) model. The operations may further include, after inserting the visual element anchor token into the series of textual fields, updating at least one respective textual offset based on the visual element offset. Each structured entity of the plurality of structured entities may include a key-value pair.

Another aspect of the disclosure provides a system for extracting visual elements from a document. The system includes data processing hardware and memory hardware in communication with the data processing hardware. The memory hardware stores instructions that when executed on the data processing hardware cause the data processing hardware to perform operations. The operations include obtaining a document that includes a series of textual fields and a visual element. For each respective textual field of the series of textual fields, the method includes determining a respective textual offset for the respective textual field. The respective textual offset indicates a location of the respective textual field relative to each other textual field of the series of textual fields in the document. The method includes detecting, using a machine learning vision model, the visual element and determining a visual element offset indicating a location of the visual element relative to each textual field of the series of textual fields in the document. The method includes assigning the visual element a visual element anchor token and inserting the visual element anchor token into the series of textual fields in an order based on the visual element offset and the respective textual offsets. After inserting the visual element anchor token into the series of textual fields, the method includes extracting, using a text-based extraction model, from the series of textual fields, a plurality of structured entities that represent the series of textual fields and the visual element.

This aspect may include one or more of the following optional features. In some implementations, the visual element includes a checkbox. Optionally, the visual element includes a radio button. For each respective textual field of the series of textual fields, the respective textual offset may include a position within an array. Each position within the array may be associated with a character of one of the series of textual fields.

In some examples, detecting the visual element includes detecting a label of the visual element and detecting a value of the visual element. In some of these examples, determining the visual element offset indicating the location of the visual element includes determining a first offset for the label of the visual element and determining a second offset for the value of the visual element.

Optionally, the visual element anchor token represents a Boolean entity indicating a status of the visual element. In some implementations, the machine learning vision model comprises an OCR model. The operations may further include, after inserting the visual element anchor token into the series of textual fields, updating at least one respective textual offset based on the visual element offset. Each structured entity of the plurality of structured entities may include a key-value pair.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for extracting visual elements from a document.

FIG. 2A is a schematic view of extracting only textual entities from a document.

FIG. 2B is a schematic view of extracting textual entities and visual elements from a document.

FIGS. 3A and 3B are schematic views of inserting tokens that represent visual elements into an array of text.

FIG. 4 a flowchart of an example arrangement of operations for a method of extracting visual elements from a document.

FIG. 5 is a schematic view of an example computing device that may be used to implement the systems and methods described herein.

Like reference symbols in the various drawings indicate like elements.

### DETAILED DESCRIPTION

Entity extraction is a popular technique that identifies and extracts key information from text. Entity extraction tools may classify the information into predefined categories which coverts previously unstructured data into structured data that downstream applications may use in any number of ways. For example, entity extraction tools may process unstructured data to extract data from documents or forms to automate many data entry tasks.

Conventional entity extraction tools (e.g., traditional deep learning models for document entity extraction) only extract textual fields (e.g., alphanumeric characters). However, visual elements such as checkboxes are highly common in documents and thus currently serve as a barrier for complete and accurate entity extraction for these conventional entity extraction tools.

Implementations herein are directed toward a document entity extractor that supports extraction of visual elements (e.g., checkboxes) as Boolean entities from documents based on deep learning vision models and text-based entity extraction models. Specifically, the document entity extractor extends the text-based entity extraction models to further support extraction of visual elements for which only spatial/geometric Cartesian coordinates are known (e.g., a bounding box) on the document page, but no supporting anchor text is known. The document entity extractor may extract the visual elements as a Boolean entity mapped to entity types defined in user-provided schemas.

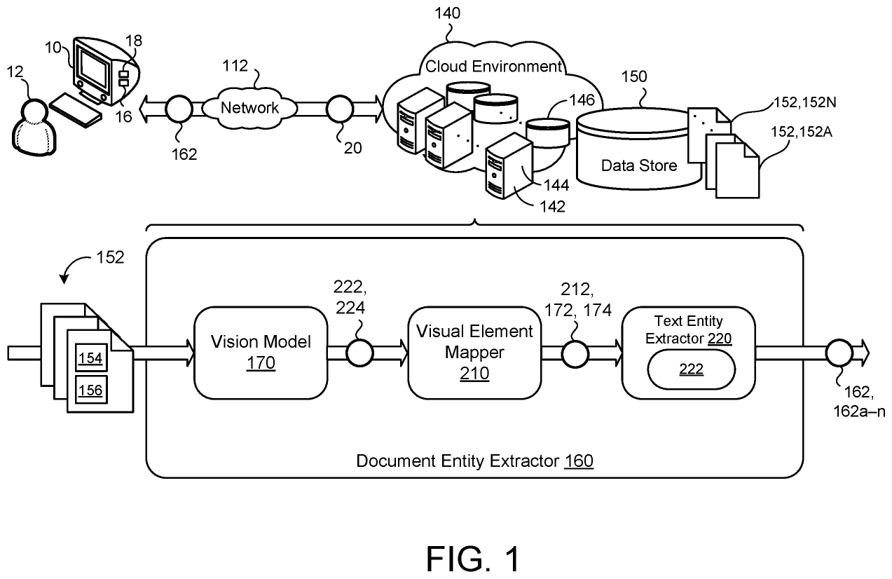

Referring to FIG. 1, in some implementations, an example document entity extraction system 100 includes a remote system 140 in communication with one or more user devices 10 via a network 112. The remote system 140 may be a single computer, multiple computers, or a distributed system (e.g., a cloud environment) having scalable/elastic resources 142 including computing resources 144 (e.g., data processing hardware) and/or storage resources 146 (e.g., memory hardware). A data store 150 (i.e., a remote storage device) may be overlain on the storage resources 146 to allow scalable use of the storage resources 146 by one or more of the clients (e.g., the user device 10) or the computing resources 144. The data store 150 is configured to store a set of documents 152, 152a-n. The documents 152 may be of any type and from any source (e.g., from the user, other remote entities, or generated by the remote system 140).

The remote system 140 is configured to receive an entity extraction request 20 from a user device 10 associated with a respective user 12 via, for example, the network 112. The user device 10 may correspond to any computing device, such as a desktop workstation, a laptop workstation, or a mobile device (i.e., a smart phone). The user device 10 includes computing resources 18 (e.g., data processing hardware) and/or storage resources 16 (e.g., memory hardware). The request 20 may include one or more documents 152 for entity extraction. Additionally or alternatively, the request 20 may refer to one or more documents 152 stored at the data store 150 for entity extraction.

The remote system 140 executes a document entity extractor 160 for extracting structured entities 162, 162a-n from the documents 152. The entities 162 represent information (e.g., values) extracted from the document that has been classified into a predefined category. In some examples, each entity 162 includes a key-value pair, where the key is the classification and the value represents the value extracted from the document 152. For example, an entity 162 extracted from a form includes a key (or label or classification) of “name” and a value of “Jane Smith.” The document entity extractor 160 receives the documents 152 (e.g., from the user device 10 and/or the data store 150).

The document entity extractor 160 includes a text entity extractor 220. In some examples, the text entity extractor 220 is a text span-based model. A text span is a continuous text segment. The text entity extractor 220 may only be capable of extracting textual fields and not visual elements. Thus, in some implementations, the text entity extractor 220 is a conventional or traditional entity extractor that is known in the art.

In some implementations, the documents 152 received by the document entity extractor 160 include a series of textual fields 154 and one or more visual elements 156. For example, the document 152 includes a checkbox or a radio button. A checkbox may come in a variety of different forms. For example, the checkbox may be situated with a description to the left or right of the checkbox. As another example, the checkbox may be situated with the description above or below the checkbox. In yet other examples, the checkbox may be nested (i.e., a nested structure where multiple checkbox options exist in a hierarchical structure) or may be keyless (i.e., do not have a description nearby or appear in conjunction with other checkboxes in a table with row/column descriptions). While examples herein discuss the visual element 156 as a checkbox, the visual element 156 may be any non-text element associated with a value that the text entity extractor 220 cannot extract, such as signatures, barcodes, yes/no fields, graphs, etc. Because the text entity extractor 220 generally cannot extract the visual elements 156, the document entity extractor 160, in order to extend functionality of the text entity extractor 220, includes a vision model 170.

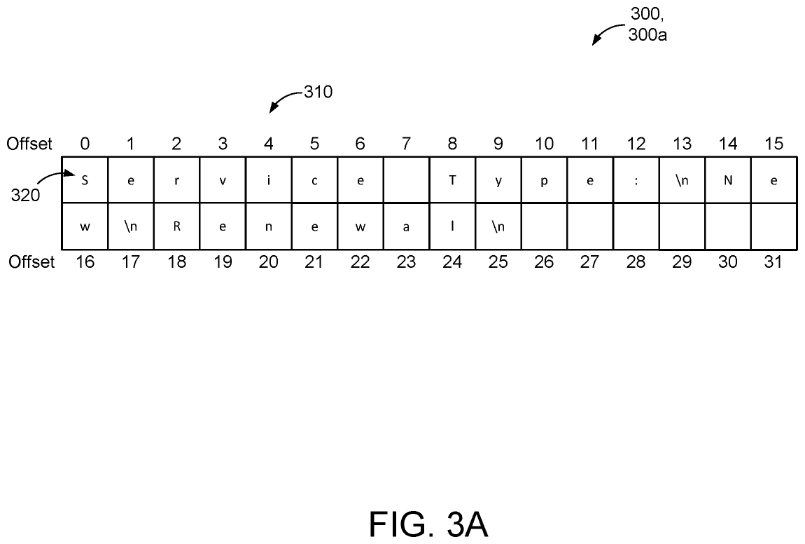

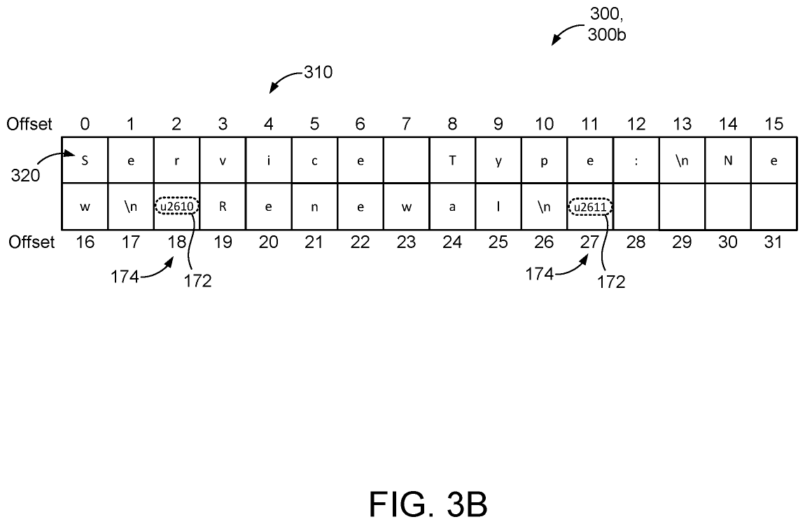

The vision model 170 includes, for example, a machine learning vision model that detects the presence of any visual elements 156 within the document 152. For example, the vision model 170 detects one or more checkboxes using bounding boxes. In these examples, the vision model 170 determines coordinates for a bounding box that surrounds the detected visual element 156. In some examples, the vision model 170 or the document entity extractor, for each respective textual field 154 of the document 152, determines a respective textual offset 212 for the respective textual field 154. The textual offset 212 indicates a location of the respective textual field 154 relative to each other textual field 154 in the document 152. That is, the textual offset 212 includes or represents a position within an array 300 (FIGS. 3A and 3B). The vision model 170 may employ techniques such as optical character recognition (OCR) (e.g., the vision model 170 may include an OCR model).

The vision model 170 may be trained on annotated documents 152 labeled with the visual elements 156. For example, the user 12 may upload to the document entity extractor 160 sample documents 152 with annotations (e.g., bounding boxes) labeling the locations of the visual elements 156 (e.g., checkboxes, radio buttons, signatures, etc.). Based on the annotated documents 152, the vision model 170 learns to detect the location of the visual elements 156. To ensure that most or all visual elements 156 are detected, the vision model 170 may be trained with a high recall even if the high recall results in a lower precision (i.e., false positives). Downstream processing may deal with lower precision successfully, but may not be able to overcome a low recall (i.e., failing to detect a visual element 156). That is, the vision model 170 may detect visual elements with low confidence thresholds.

The document entity extractor 160 includes a visual element mapper 210. The visual element mapper 210 receives, from the vision model 170, the textual offsets 212 and any information the vision model 170 associates with the visual elements 156. For example, the vision model 170 provides location information 224 (e.g., bounding box coordinates) along with the textual offsets 212 to the visual element mapper 210. The visual element mapper 210, in some examples, assigns each visual element 156 in the document 152 a visual element anchor token 172. The visual element anchor token 172 is a textual representation of the visual element 156. In some implementations, the visual element anchor tokens are unicode symbols. For example, an unchecked checkbox is be assigned a visual element anchor token 172 equivalent to unicode “u2610” (i.e., a “ballot box” symbol) while a checked checkbox is be assigned a visual element anchor token 172 equivalent to unicode “u2611” (i.e., a “ballot box with check” symbol). Different types of visual elements 156 may be assigned different visual element anchor tokens 172.

The visual element mapper 210 determines a visual element offset 174 for each visual element 156 detected by the vision model 170. The visual element offset 174 indicates a location of the visual element 156 relative to each textual field 154 in the document 152. For example, the visual element mapper 210 determines the visual element offset 174 using the location information 224 provided by the vision model 170 (e.g., a bounding box). As described in more detail below, the visual element mapper 210 inserts each visual element anchor token 172 into the series of textual fields 154 (e.g., a text span) in an order based on the respective visual element offset 174 and the respective textual offsets 212 of the textual fields 154.

After inserting the visual element anchor tokens 172 into the textual fields 154, the visual element mapper 210 provides the text entity extractor 220 the textual offsets 212 with the visual element anchor tokens 172 inserted at the respective visual element offsets 174. The text entity extractor 220 extracts, using a text-based extraction model 222, the structured entities 162. The structured entities 162 represent the series of textual fields 154 and the visual element(s) 156. In some examples, the text-based extraction model 222 is a natural language processing (NLP) machine learning model trained to automatically identify and extract specific data from unstructured text (e.g., text spans) and classify the information based on predefined categories. The text entity extractor 220 classifies the visual element anchor tokens 172 into appropriate entity types and determines a value (e.g., a Boolean value) based on information provided by the vision model 170 and/or the visual element mapper 210. The document entity extractor 160 may provide the extracted entities 162 to the user device 10, store them at the data store 150, and/or further process the entities 162 with downstream applications.

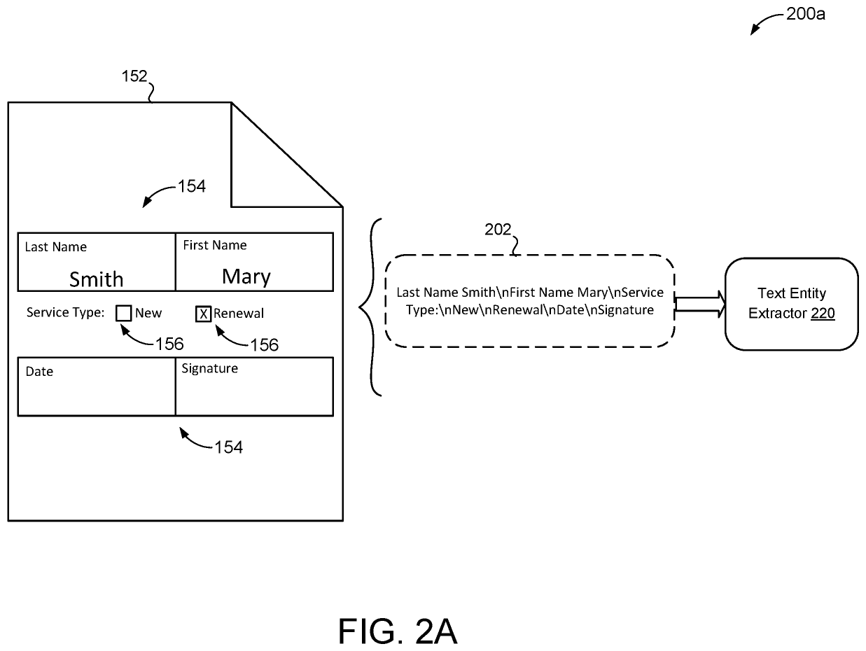

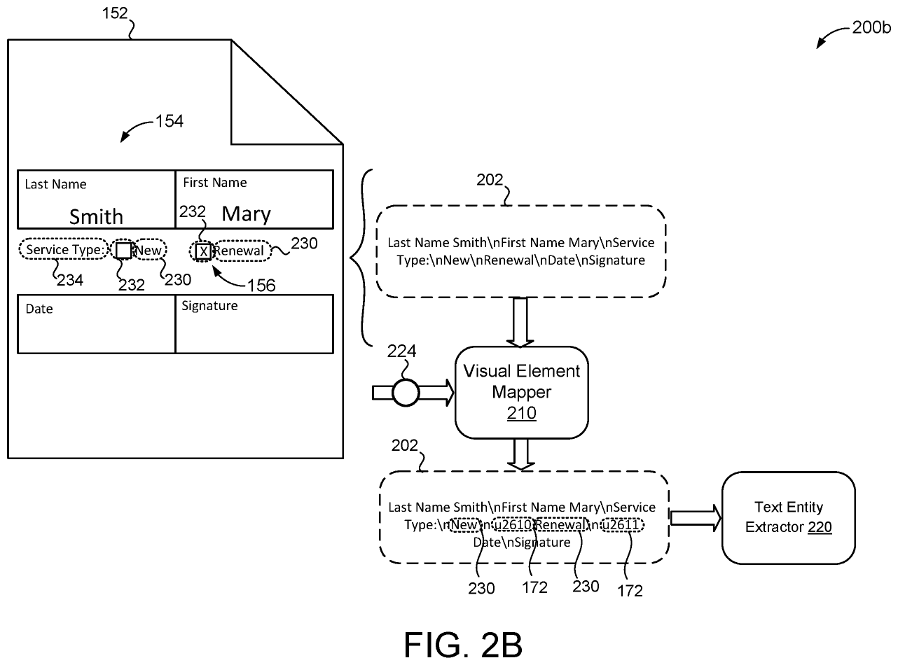

Referring now to FIG. 2A, a schematic view 200a includes an example document 152 with textual fields 154 and visual elements 156. Here, the document 152 is a form with a textual field 154 for a “Last Name” that has been filled with “Smith,” a textual field 154 for a “First Name” filled with “Mary,” a service type field that includes two checkboxes (i.e., visual elements 156) with one labeled “New” and one labeled “Renewal,” and blank “Date” and “Signature” textual fields 154. Using conventional extraction systems, the text entity extractor 220, as shown in this example, is provided with a text span 202 that includes text from the textual fields 154. In this example, the text span 202 includes the labels of visual elements 156 (i.e., “New” and “Renewal” here) but does not include the values of the visual elements 156 (i.e., whether the checkboxes are checked). Thus, the text entity extractor 220 loses access to this information, which is likely to be important to users 12.

Referring now to FIG. 2B, a schematic view 200b includes the same example document 152 from FIG. 2A. Here, the visual element mapper 210 receives the textual fields 154 along with the location information 224 of the visual elements 156. The visual element mapper 210 inserts the visual element anchor tokens 172, which here are unicode values “u2610” and “u2611” into the text span 202 based on the visual element offsets 174 determined from the location information 224. In some examples, the visual element mapper 210 inserts the visual element anchor tokens 172 into the text span 202 (or any other text-based structure) based on positional relationships with the textual fields 154 of the document 152. For example, the visual element mapper 210 inserts the visual element anchor tokens 172 next to text of textual fields 154 that are in close proximity (as located on the document 152) to the visual element 156. Here, the visual elements 156 (i.e., the checkboxes) are in close proximity to the labels “New” and “Renewal” and accordingly the visual element mapper 210 inserts the visual element anchor tokens 172 (i.e., u2610 and u2611) after “New” and “Renewal” (and delimiter symbols “\n”) respectively.

In some examples, the document entity extractor 160 detects the visual element 156 by detecting a label 230 of the visual element 156 and detecting a value 232 of the visual element 156. The value 232 reflects a status of the visual element 156 (e.g., whether a checkbox is checked or unchecked) and the label 230 provides information defining the value 232. The document entity extractor 160 may represent the value 232 as a Boolean value. That is, the visual element anchor token 172 may represent a Boolean entity indicating a status of the visual element 156. For example, the document entity extractor 160 defines the value 232 of a checkbox as “true” when the checkbox is checked and “false” when the checkbox is not checked. In some examples, the label 230 and value 232 define a key-value pair. Here, the label 230 “New” defines the value 232 for a first checkbox (which is not checked or false) and the label 230 (i.e., the key) “Renewal” defines the value 232 for a second checkbox (which is checked or true).

Optionally, the document entity extractor 160 determines a type 234 for the visual element 156. The type may provide additional classification of the visual element 156. For example, the type 234 classifies the visual element 156 and the label 230 subclassifies the classification. Here, a type 234 “Service Type:” classifies the two visual elements 156 which are further classified as either “New” or “Renewal.”

In some implementations, the document entity extractor 160, when determining the visual element offset 174, determines a first offset for the label 230 of the visual element 156 and a second offset for the value 232 of the visual element 156. In these implementations, the visual element mapper 210 maps the visual element anchor token 172 (which may represent the value 232 of the visual element 156) near (e.g., immediately after) the text representing the label 230 of the visual element 156. For example, when the label 230 is located to the left or above the value 232, the visual element mapper 210 maps the visual element anchor token 172 immediately after the label 230 in the text. When the visual element 156 does not have an apparent label 230, the visual element mapper 210 may locate the closest textual field 154 to the left horizontally of the visual element 156 and insert the visual element anchor token 172 to the right of (i.e., immediately after) the located textual field 154. Here, the visual element mapper 210 inserts the visual element anchor token 172 into the text span 202 immediately after the corresponding labels 230 (i.e., “u2610” immediately after “New” and “u2611” immediately after “Renewal”). The visual element mapper 210 may determine the relative positions of the label 230 and value 232 based on the location information 224 provided by the vision model 170, which may include bounding boxes or other annotations around the textual fields 154 in addition to the visual elements 156.

Referring now to FIG. 3A, in some implementations, the textual offsets 212 of the textual fields 154 represent positions or locations within an array 300. For example, each position within the array 300 is associated with a single character of one of the textual fields 154. Here, an exemplary array 300, 300a includes a portion of the text from the document 152 of FIGS. 2A and 2B. The array 300a includes 32 positions with each assigned a respective offset 310 from 0-31. The document entity extractor 160 inserts the textual fields 154 into the array 300 in an order based on the respective textual offsets 212 of each textual field 154. Optionally, a portion of the offsets 310 (i.e., positions within the array 300a) are occupied by a single characters 320 of the textual fields 154 from the document 152. Here, the array 300a includes the text “Service Type:\nNew\nRenewal\n.” In this example, the values of the visual elements 156 (i.e., the checkboxes) is not yet included within the array 300a and the text ends at the offset 310 of 25.

Referring now to FIG. 3B, after the visual element mapper 210 inserts the visual element anchor tokens 172 at the visual element offsets 174, the values of the visual elements 156 are represented in the array 300. Here, another exemplary array 300, 300b includes the same text as the array 300a from FIG. 3A with the visual element anchor tokens 172 inserted. Here, the visual element mapper 210 determines that the visual element offset 174 of a visual element anchor token 172 is “18” and inserts the visual element anchor token 172 into the array 300b at the offset 310 of 18. Similarly, the visual element mapper 210 inserts another visual element anchor token 172 into the array 300b at the offset 310 of 27. Notably, because inserting the visual element anchor tokens 172 into the array 300 occupies offsets 310 within the array 300, the textual offsets 212 of the textual fields 154 may need adjustment or updating. Here, the characters for “Renewal\n” are each shifted one offset 310 to account for the insertion of one of the visual element anchor tokens 172. The visual element mapper 210 may insert the visual element anchor tokens 172 sequentially and update the offsets 310 accordingly between insertions based on the visual element offset 174. While in this example the visual element anchor tokens 172 occupy a single position within the array 300 (as they represent a single symbol), the visual element anchor tokens 172 may occupy additional positions with corresponding updates to the textual offsets 212 of the textual fields 154.

Thus, the document entity extractor 160 extends text-based extraction models 222 to support visual elements 156 such as checkboxes for which spatial/geometric positions (e.g., a bounding box) are known but supporting anchor text is unknown. The document entity extractor 160 extracts the visual elements 156 as, for example, Boolean entities 162 mapped to entity types in a user-provided schema. The document entity extractor 160, using a vision model 170, detects the visual elements 156 of a document 152 and assigns special symbols (i.e., visual element anchor tokens 172) to each visual element 156. The document entity extractor 160 inserts the special symbols into the text of the document 152 at determined visual element offsets 174 based on the location of the visual element 156 within the document 152. The document entity extractor 160 may employ a conventional layout-aware text-based entity extractor (e.g., an NLP model 222) to extract structured entities 162 from the text. Thus, the document entity extractor 160 allows for reliable extraction of visual elements 156 (e.g., checkboxes) as structured Boolean entity types without employing more complex and computationally expensive image-based models.

While examples herein discuss the document entity extractor 160 as executing on the remote system 140, some or all of the document entity extractor 160 may execute locally on the user device 10. For example, at least a portion of the document entity extractor 160 executes on the data processing hardware 18 of the user device 10.

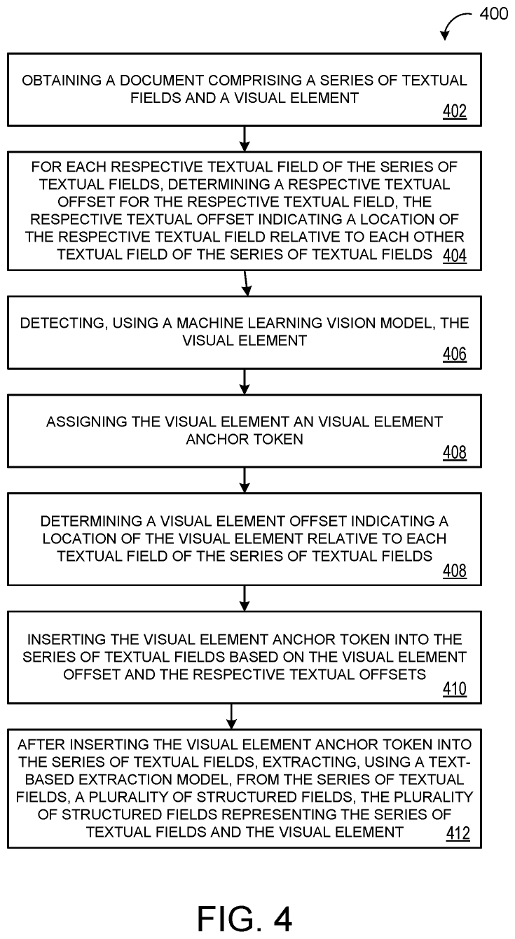

FIG. 4 is a flowchart of an exemplary arrangement of operations for a method 400 for extracting visual elements 156 from a document 152. The computer-implemented method 400, when executed by data processing hardware 144, causes the data processing hardware 144 to perform operations. The method 400, at operation 402, includes obtaining a document 152 that includes a series of textual fields 154 and a visual element 156. For each respective textual field 154 of the series of textual fields 154, the method 400, at operation 404, includes determining a respective textual offset 212 for the respective textual field 154. The respective textual offset 212 indicates a location of the respective textual field 154 relative to each other textual field 154 of the series of textual fields 154 in the document 152. The method 400, at operation 406, includes detecting, using a machine learning vision model 170, the visual element 156 and determining a visual element offset 174 indicating a location of the visual element 156 relative to each textual field 154 of the series of textual fields 154 in the document 152. The method 400, at operation 408, includes assigning the visual element 156 a visual element anchor token 172 and, at operation 410, inserting the visual element anchor token 172 into the series of textual fields 154 in an order based on the visual element offset 174 and the respective textual offsets 212. After inserting the visual element anchor token 172 into the series of textual fields 154, the method 400, at operation 412, includes extracting, using a text-based extraction model 222, from the series of textual fields 154, a plurality of structured entities 162 that represent the series of textual fields 154 and the visual element 156.

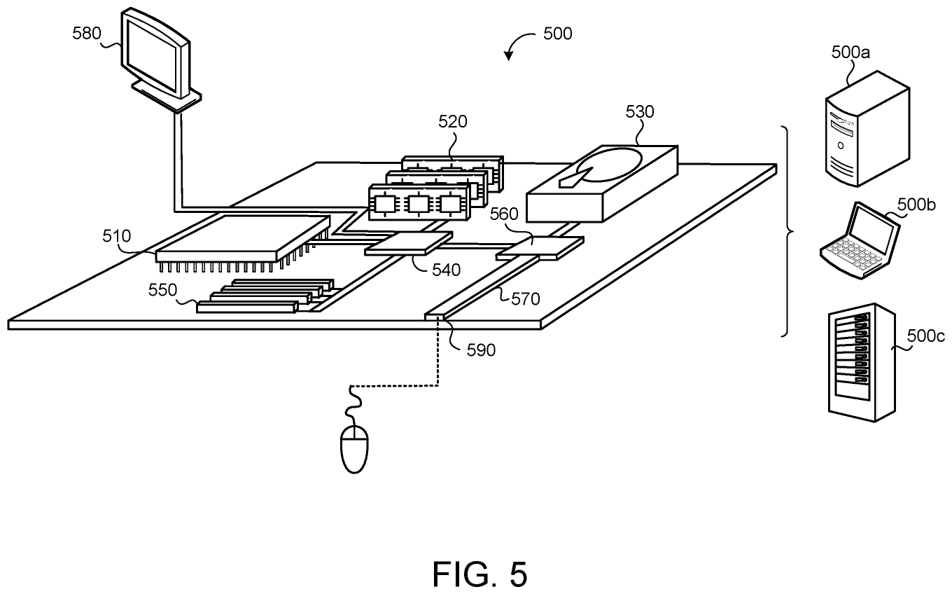

FIG. 5 is a schematic view of an example computing device 500 that may be used to implement the systems and methods described in this document. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510, memory 520, a storage device 530, a high-speed interface/controller 540 connecting to the memory 520 and high-speed expansion ports 550, and a low speed interface/controller 560 connecting to a low speed bus 570 and a storage device 530. Each of the components 510, 520, 530, 540, 550, and 560, are interconnected using various busses, and may be mounted on a common motherboard or in other manners as appropriate. The processor 510 can process instructions for execution within the computing device 500, including instructions stored in the memory 520 or on the storage device 530 to display graphical information for a graphical user interface (GUI) on an external input/output device, such as display 580 coupled to high speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 520, the storage device 530, or memory on processor 510.

The high speed controller 540 manages bandwidth-intensive operations for the computing device 500, while the low speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed by data processing hardware that causes the data processing hardware to perform operations comprising:
obtaining a document comprising:
a series of textual fields; and
a visual element;
for each respective textual field of the series of textual fields, determining a respective textual offset for the respective textual field, the respective textual offset indicating a location of the respective textual field relative to each other textual field of the series of textual fields in the document;
detecting, using a machine learning vision model, the visual element;
determining a visual element offset indicating a location of the visual element relative to each textual field of the series of textual fields in the document;
assigning the visual element a visual element anchor token;
inserting the visual element anchor token into the series of textual fields in an order based on the visual element offset and the respective textual offsets; and
after inserting the visual element anchor token into the series of textual fields, extracting, using a text-based extraction model, from the series of textual fields, a plurality of structured entities, the plurality of structured entities representing the series of textual fields and the visual element.

2. The method of claim 1, wherein the visual element comprises a checkbox.

3. The method of claim 1, wherein the visual element comprises a radio button.

4. The method of claim 1, wherein, for each respective textual field of the series of textual fields, the respective textual offset comprises a position within an array.

5. The method of claim 4, wherein each position within the array is associated with a character of one of the series of textual fields.

6. The method of claim 1, wherein detecting the visual element comprises:
detecting a label of the visual element; and
detecting a value of the visual element.

7. The method of claim 6, wherein determining the visual element offset indicating the location of the visual element comprises:
determining a first offset for the label of the visual element; and
determining a second offset for the value of the visual element.

8. The method of claim 1, wherein the visual element anchor token represents a Boolean entity indicating a status of the visual element.

9. The method of claim 1, wherein the machine learning vision model comprises an optical character recognition (OCR) model.

10. The method of claim 1, wherein the operations further comprise, after inserting the visual element anchor token into the series of textual fields, updating at least one respective textual offset based on the visual element offset.

11. The method of claim 1, wherein each structured entity of the plurality of structured entities comprises a key-value pair.

12. A system comprising:
data processing hardware; and
memory hardware in communication with the data processing hardware, the memory hardware storing instructions that when executed on the data processing hardware cause the data processing hardware to perform operations comprising:
obtaining a document comprising:
a series of textual fields; and
a visual element;
for each respective textual field of the series of textual fields, determining a respective textual offset for the respective textual field, the respective textual offset indicating a location of the respective textual field relative to each other textual field of the series of textual fields in the document;
detecting, using a machine learning vision model, the visual element;
determining a visual element offset indicating a location of the visual element relative to each textual field of the series of textual fields in the document;
assigning the visual element a visual element anchor token;
inserting the visual element anchor token into the series of textual fields in an order based on the visual element offset and the respective textual offsets; and
after inserting the visual element anchor token into the series of textual fields, extracting, using a text-based extraction model, from the series of textual fields, a plurality of structured entities, the plurality of structured entities representing the series of textual fields and the visual element.

13. The system of claim 12, wherein the visual element comprises a checkbox.

14. The system of claim 12, wherein the visual element comprises a radio button.

15. The system of claim 12, wherein, for each respective textual field of the series of textual fields, the respective textual offset comprises a position within an array.

16. The system of claim 15, wherein each position within the array is associated with a character of one of the series of textual fields.

17. The system of claim 12, wherein detecting the visual element comprises:
detecting a label of the visual element; and
detecting a value of the visual element.

18. The system of claim 17, wherein determining the visual element offset indicating the location of the visual element comprises:
determining a first offset for the label of the visual element; and
determining a second offset for the value of the visual element.

19. The system of claim 12, wherein the visual element anchor token represents a Boolean entity indicating a status of the visual element.

20. The system of claim 12, wherein the machine learning vision model comprises an optical character recognition (OCR) model.

21. The system of claim 12, wherein the operations further comprise, after inserting the visual element anchor token into the series of textual fields, updating at least one respective textual offset based on the visual element offset.

22. The system of claim 12, wherein each structured entity of the plurality of structured entities comprises a key-value pair.
